(19) United States
(12) Patent Application Publication
(10) Pub. No.: US 2009/0158833 A1
(43) Pub. Date: Jun. 25, 2009

(54) FUEL INJECTOR MALFUNCTION MONITORING APPARATUS AND METHOD

(75) Inventor: Hideyuki KUSATSUGU, Kariya-shi (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/339,840

(22) Filed: Dec. 19, 2008

(30) Foreign Application Priority Data
Dec. 19, 2007 (JP) 2007-326735

(51) Int. Cl. G01M 15/04

(52) U.S. Cl. 73/114.45

(57) ABSTRACT

A fuel injector malfunction monitoring apparatus designed to monitor a malfunction of fuel injectors which are installed in cylinders of an internal combustion engine and work to spray fuel in response to a fuel injection command signal. The apparatus comprises an injector operation disabling circuit and a state monitoring circuit. The injector operation disabling circuit works to disable the fuel injection command signal to place a selected one of the fuel injectors in a non-injection mode during operation of the internal combustion engine for inducing a change in state of the engine arising from stop of spraying of the fuel. The state monitoring circuit works to monitor the state of the internal combustion engine upon placement of the selected one of the fuel injectors in the non-injection mode for use in determining whether the selected on is malfunctioning or not.

### CROSS REFERENCE TO RELATED DOCUMENT

The present application claims the benefit of Japanese Patent Application No. 2007-326735 filed on Dec. 19, 2007, the disclosure of which is incorporated herein by reference.

### BACKGROUND OF THE INVENTION

1. Technical Field of the Invention

The present invention relates generally to a fuel injector malfunction monitoring apparatus designed to monitor a malfunction of fuel injectors installed in a multi-cylinder internal combustion engine and a method for monitoring such a malfunction.

2. Background Art
Typical fuel injectors for use in spraying fuel into internal combustion engines have the problem in that they are clogged with foreign objects contained in the fuel, which results in a failure in operation of a lift mechanism to open or close the spray hole, or the foreign objects are deposited to the spray hole, which results in spraying of no fuel or a lack of quantity of fuel sprayed.

A variation in quantity of the fuel among cylinders of the internal combustion engine will result in a variation in speed of the engine within a combustion cycle (i.e., a four-stroke cycle) including intake or induction, compression, expansion, and exhaust). There is known a technique for correcting the quantity of fuel to be sprayed by each of the fuel injectors using a correction factor, as determined based on a deviation of an averaged speed of the engine in the combustion cycle from an instantaneous speed of the engine upon an expansion stroke of a corresponding one of the cylinders, thereby minimizing the variation in speed of the engine The correction factor will, therefore, have a greater value when the deviation arises from one of the fuel injectors which is malfunctioning so that no fuel is sprayed.

Japanese Patent First Publication No. 2-5736 discloses a fuel injector malfunction monitor which is designed in view of the above fact to determine that one of the fuel injectors is malfunctioning when a corresponding one of the correction factors is greater than a given value.

However, the deviation of the averaged speed of the engine from the instantaneous speed thereof, as produced by spraying of the fuel from a malfunctioning one of the fuel injectors, is also small, which may result in an error of the malfunction determination when the instantaneous speed of the engine is deviated from the average speed by some factor other than the malfunction of the fuel injector.

### SUMMARY OF THE INVENTION

It is therefore a principal object of the invention to avoid the disadvantages of the prior art.

It is another object of the invention to provide fuel injector malfunction monitoring apparatus and method which ensures the accuracy in monitoring the malfunction of fuel injectors.

According to one aspect of the invention, there is provided a fuel injector malfunction monitoring apparatus which is designed to monitor a malfunction of fuel injectors which are installed in cylinders of an internal combustion engine and work to spray fuel in response to a fuel injection command signal. The fuel injector malfunction monitoring apparatus comprises: (a) an injector operation disabling circuit which works to disable the fuel injection command signal to place a selected one of the fuel injectors in a non-injection mode during operation of the internal combustion engine; (b) a state monitoring circuit working to monitor a state of the internal combustion engine upon placement of the selected one of the fuel injectors in the non-injection mode; and (c) a diagnosis circuit working to diagnose whether the selected one of the fuel injectors is malfunctioning or not based on the state of the internal combustion engine, as monitored by the state monitoring circuit.

Specifically, when the fuel injector which is operating properly is placed in the non-injection mode, it is stopped from spraying the fuel suddenly, it will result in a great change in state of the internal combustion engine. Alternatively, when the fuel injector which is malfunctioning is placed in the non-injection mode, it means that the fuel continues not to be sprayed therefrom, so that the state of the internal combustion engine hardly changes. Therefore, when one of the fuel injectors has been placed in the non-injection mode, but the state of the internal combustion engine hardly changes, it may be determined as being malfunctioning.

The malfunction determination may alternatively be made based on comparison between a change in state of the internal combustion engine arising from the placement of one of the fuel injectors which is operating properly in the non-injection mode and that arising from the placement of one of the fuel injectors which is malfunctioning in the non-injection mode. Specifically, the change in state of the engine, as described above, appears to be great in the case where the fuel injector which is operating properly is placed in the non-injection mode, while it hardly appears in the case where the fuel injector which is malfunctioning is placed in the non-injection mode. The use of this fact minimizes the error of the malfunction determination.

The length of time the non-injection mode continues to be executed cyclically may be selected to be longer than the combustion cycle of the engine. This ensures the accuracy in finding the change in state of the engine arising from the placement of the fuel injector in the non-injection mode.

In the preferred mode of the invention, when the state of the internal combustion engine, as monitored by the state monitoring circuit, remains unchanged upon the placement of the selected one of the fuel injectors in the non-injection mode, the diagnosis circuit determines that the selected one of the fuel injectors is malfunctioning. This improves the accuracy of the malfunction determination as compared with when a human operator visually perceives the change in state of the engine to determine whether the selected one of the fuel injectors is malfunctioning or not.

The internal combustion engine may be installed in an automotive vehicle. The fuel injector malfunction monitoring apparatus comprises ISC means for determining a target quantity of fuel to be sprayed by the fuel injectors to place the internal combustion engine in an idle mode in which a speed of the internal combustion engine is kept above a given idle speed when a vehicle operator is releasing an accelerator. The injector operation disabling circuit places the selected one of the fuel injectors in the non-injection mode when the internal combustion engine is placed in the idle mode.

Specifically, when one of the fuel injectors which is operating properly is placed in the non-injection mode, it will result in a drop in speed of the engine to drop. This causes the target quantity of fuel to be increased by the ISC means so as to keep the speed of the above the given idle speed. In other words, the amount by which the target quantity of fuel required for the fuel injector which is operating properly is corrected will be great, which results in an increase in instantaneous speed of the engine upon the expansion stroke of the piston, thus leading to a great variation in the instantaneous speed during the combustion cycle of the engine.

Alternatively, when one of the fuel injectors which is malfunctioning is placed in the non-injection mode, the target quantity of fuel and the speed of the engine hardly change. Therefore, when the non-injection mode is entered during the execution of the ISC means, the quantity of fuel sprayed into the engine and the speed of the engine change. The state monitoring circuit finds such an event for use in the malfunction determination.

In the case where the internal combustion engine is installed in the automotive vehicle, the malfunction of the fuel injectors may be monitored while the vehicle is at rest, thereby ensuring the drivability of the vehicle during running thereof. In the case where the malfunction of the fuel injectors is monitored, for example, at motor vehicle workshops, such monitoring may be made when the engine is idling, thus keeping working environment quiet.

The ISC means may determine the target quantity of fuel to be sprayed by the fuel injectors to place the internal combustion engine in an idle mode in which the speed of the internal combustion engine is kept above the given idle speed when a vehicle operator is releasing an accelerator. The injector operation disabling circuit places the selected one of the fuel injectors in the non-injection mode when the internal combustion engine is placed in an accelerator-response mode in which the injector operation disabling circuit determines the target quantity of fuel to be sprayed from the fuel injectors based on a position of the accelerator and a speed of the internal combustion engine, and the internal combustion engine is placed out of the idle mode.

Specifically, when one of the fuel injectors which is operating properly is placed in the non-injection mode, it will result in a drop in speed of the engine to drop. This causes the target quantity of fuel which is to be determined as a function of the position of the accelerator and the speed of the engine to be increased. In other words, the amount by which the target quantity of fuel required for the fuel injector which is operating properly is corrected will be great, which results in an increase in instantaneous speed of the engine upon the expansion stroke of the piston, thus leading to a great variation in the instantaneous speed during the combustion cycle of the engine.

Alternatively, when one of the fuel injectors which is malfunctioning is placed in the non-injection mode, the target quantity of fuel and the instantaneous speed of the engine hardly change. Therefore, when the non-injection mode is entered during the execution of the accelerator-response mode, the quantity of fuel sprayed into the engine and the speed of the engine change as described above. The state monitoring circuit finds such an event for use in the malfunction determination.

The fuel injector malfunction monitoring apparatus may further comprises engine speed accelerating means for accelerating the speed of the internal combustion engine without performing the ISC means when the automotive vehicle is being stopped, and the vehicle operator is releasing the accelerator. The accelerator-response mode is to execute the engine speed accelerating means. Specifically, the malfunction determination may be made when the vehicle is at rest and idling, and the speed of the engine is being increased by the engine speed accelerating means. In other words, the malfunction determination may be made when the speed of the engine is higher than that when the engine is idling through the ISC means, thus ensuring the accuracy of the malfunction determination.

The fuel injector malfunction monitoring apparatus may further comprise during-deceleration fuel spraying smoothing means for decreasing a target quantity of the fuel to be sprayed from the fuel injectors smoothly when a vehicle operator is releasing an accelerator to decelerate the internal combustion engine. The injector operation disabling circuit places the selected one of the fuel injectors in the non-injection mode when the during-deceleration fuel spraying smoothing means is being executed.

Specifically, the during-deceleration fuel spraying smoothing means avoids a rapid drop in speed of the engine upon release of the accelerator, thereby reducing the uncomfortable shock upon execution of the non-injection mode. However, when one of the fuel injectors which is operating properly is placed in the non-injection mode during the execution of the during-deceleration fuel spraying smoothing means, it will cause the spraying of fuel spray to be cut immediately, so that the speed of the engine drops rapidly.

Alternatively, when one of the fuel injectors which is malfunctioning is placed in the non-injection mode, the state of the engine hardly changes. The state monitoring circuit finds such an event for use in the malfunction determination.

The state monitoring circuit may monitor, as the state of the internal combustion engine, a change in quantity of fuel to be sprayed from the fuel injectors other than the selected one of the fuel injectors upon placement of the selected one of the fuel injectors in the non-injection mode.

The state monitoring circuit may alternatively monitor, as the state of the internal combustion engine, a change in speed of the internal combustion engine upon placement of the selected one of the fuel injectors in the non-injection mode.

The state monitoring circuit may alternatively monitor, as the state of the internal combustion engine, a change in operating noise of the internal combustion engine upon placement of the selected one of the fuel injectors in the non-injection mode.

In the case where the internal combustion engine is mounted as a power source in the automotive vehicle, the injector operation disabling circuit may be installed in an electronic control unit mounted in the vehicle to control an operation of the fuel injectors and work to place the selected one of the fuel injectors in the non-injection mode in response to a non-injection request signal from outside the vehicle.

Additionally, at least one of the injector operation disabling circuit and the state monitoring circuit is installed in an external diagnosis device provided outside the vehicle.

According to the second aspect of the invention, there is provided a fuel injector malfunction monitoring method for monitoring a malfunction of fuel injectors which are installed in cylinders of an internal combustion engine and work to spray fuel in response to a fuel injection command signal. The method comprises: (a) disabling the fuel injection command signal to place a selected one of the fuel injectors in a non-injection mode during operation of the internal combustion engine; (b) determining whether an operating condition of the internal combustion engine has been changed or not due to placement of the selected one of the fuel injectors in the non-injection mode; and (c) diagnosing that the selected one of the fuel injectors is malfunctioning when the operating condition of the internal combustion engine is determined not to have been changed.

In the preferred mode of the invention, the internal combustion engine may be installed in an automotive vehicle which includes ISC means for determining a target quantity of fuel to be sprayed by the fuel injectors to place the internal combustion engine in an idle mode in which a speed of the internal combustion engine is kept above a given idle speed when a vehicle operator is releasing an accelerator. In this case, the disabling step places the selected one of the fuel injectors in the non-injection mode when the internal combustion engine is placed in the idle mode.

The disabling step may alternatively place the selected one of the fuel injectors in the non-injection mode when the internal combustion engine is placed in an accelerator-response mode in which the disabling step determines a target quantity of fuel to be sprayed from the fuel injectors based on a position of the accelerator and a speed of the internal combustion engine, and the internal combustion engine is placed out of the idle mode.

The fuel injector malfunction monitoring method may further comprise the step of accelerating the speed of the internal combustion engine without performing the ISC means when the vehicle operator is releasing the accelerator. The selected one of the fuel injectors is placed in the non-injection mode when the speed of the internal combustion engine is being accelerated.

The disabling step may be achieved in an electronic control unit mounted in the vehicle to control an operation of the fuel injectors and work to disable the fuel injection command signal, as outputted from the electronic control unit, to place the selected one of the fuel injectors in the non-injection mode in response to a non-injection request signal from outside the vehicle.

The disabling step may be achieved in the electronic control unit mounted in the vehicle and alternatively work to remove a connector of a harness through which the fuel injection command signal is transmitted from the electronic control unit to the fuel injectors to place the selected one of the fuel injectors in the non-injection mode.

The determining step determines whether an operating condition of the internal combustion engine has been changed or not based on a change in quantity of fuel to be sprayed from the fuel injectors other than the selected one of the fuel injectors upon placement of the selected one of the fuel injectors in the non-injection mode.

The determining step may alternatively determine whether the operating condition of the internal combustion engine has been changed or not based on a change in speed of the internal combustion engine upon placement of the selected one of the fuel injectors in the non-injection mode.

The determining step may alternatively determine whether the operating condition of the internal combustion engine has been changed or not based on a change in operating noise of the internal combustion engine upon placement of the selected one of the fuel injectors in the non-injection mode.

### BRIEF DESCRIPTION OF THE DRAWINGS

The present invention will be understood more fully from the detailed description given hereinbelow and from the accompanying drawings of the preferred embodiments of the invention, which, however, should not be taken to limit the invention to the specific embodiments but are for the purpose of explanation and understanding only.

In the drawings:

FIG. 1 is a block diagram which illustrates a fuel injector malfunction monitoring system which is used with a fuel injection system according to the first embodiment of the invention;

FIG. 2 is a flowchart of an ISC program to be executed by the fuel injection system of FIG. 1 to control an idle speed of an internal combustion engine;

FIG. 3(a) is a view which demonstrate a variation in instantaneous speed of an engine among cylinders;

FIG. 3(b) is a view which demonstrates a variation in instantaneous speed of an engine among cylinders when the quantity of fuel to be sprayed from each fuel injector is corrected;

FIG. 4 is a flowchart of a malfunction monitoring program to be executed in the first embodiment of the invention to diagnose fuel injectors;

FIG. 5(a) is a table which represents quantities of fuel to be sprayed from fuel injectors where all the fuel injectors are operating properly;

FIG. 5(b) is a table which represents quantities of fuel to be sprayed from fuel injectors where one of the fuel injectors is malfunctioning;

FIG. 6(a) represents non-injection mode flags which indicate the time when fuel injectors are to be placed in a non-injection mode in the first embodiment;

FIG. 6(b) represents a variation in speed of an engine arising from execution of a non-injection mode;

FIG. 6(c) represents a change in quantity of fuel sprayed from fuel injectors;

FIG. 6(d) represents the status of an injection failure diagnosis flag;

FIG. 7 is a block diagram which illustrates a fuel injector malfunction monitoring system which is used with a fuel injection system according to the second embodiment of the invention;

FIG. 8 is a flowchart of a malfunction monitoring program to be executed in the third embodiment of the invention to diagnose fuel injectors;

FIG. 9(a) represents non-injection mode flags which indicate the time when fuel injectors are to be placed in a non-injection mode in the third embodiment;

FIG. 9(b) represents the position of an accelerator pedal;

FIG. 9(c) represents a change in speed of an engine during deceleration of the engine;

FIG. 9(d) represents a rate of the change in speed of the engine, as illustrated in FIG. 9(c);

FIG. 9(e) represents a change in target quantity of fuel to be sprayed from fuel injectors;

FIG. 9(f) represents the status of an injection failure diagnosis flag;

FIG. 10 is a flowchart of a malfunction monitoring program to be executed in the fourth embodiment of the invention to diagnose fuel injectors;

FIG. 11 represents a throttle position-engine speed-commanded injection quantity map, as stored in an ECU of a fuel injection system of the fourth embodiment;

FIG. 12(a) demonstrates a non-injection mode flag indicating the execution of a non-injection mode in the fourth embodiment;

FIG. 12(b) demonstrates the state or position of an accelerator pedal as a function of the open position of a throttle valve;

FIG. 12(c) demonstrates a change in speed of an engine;

FIG. 12(d) demonstrates a change in commanded injection quantity required to be sprayed from fuel injectors; and

FIG. 12(e) demonstrates the status of an injection failure diagnosis flag.

### DESCRIPTION OF THE PREFERRED EMBODIMENTS

Referring to the drawings, wherein like reference numbers refer to like parts in several views, particularly to FIG. 17 there is shown a fuel injection system for diesel engines according to the first embodiment of the invention which is engineered as an automotive common rail fuel injection system equipped with fuel injectors 17 which are to be diagnosed by an injector malfunction monitoring system, as will be described later in detail.

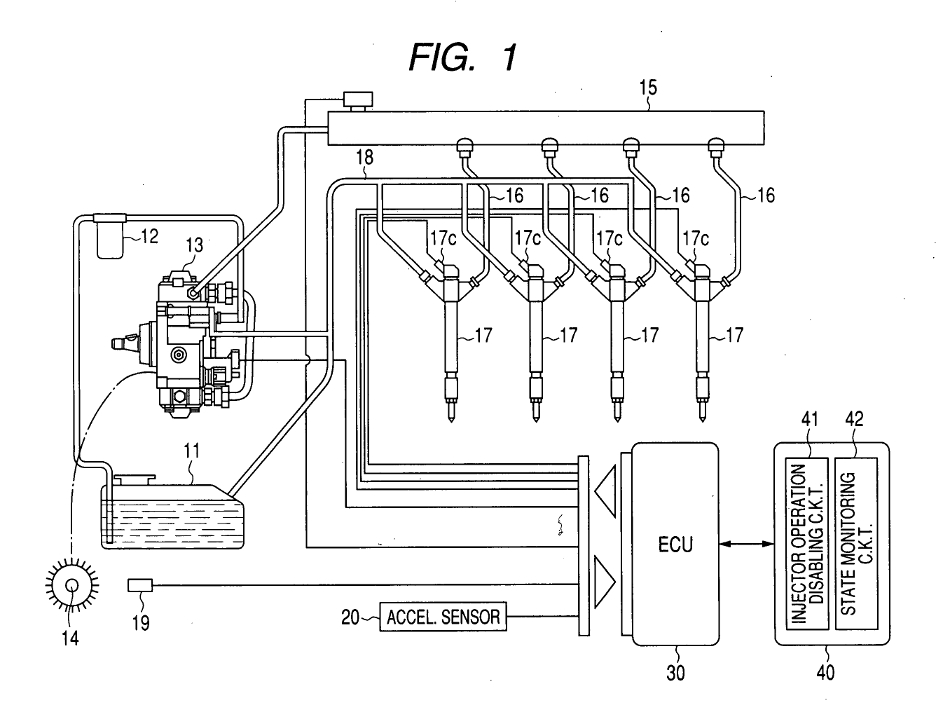

The fuel injection system includes a fuel tank 11, a fuel pump 13, a common rail 15, and the fuel injectors 17. The fuel pump 13 works to pump fuel out of the fuel tank 11 through a fuel filter 12. The fuel pump 13 is equipped with plungers which are driven by torque, as transmitted from the diesel engine through a crankshaft 14, so that they reciprocate between the top-dead center and the bottom-dead center to suck and discharge the fuel alternately. The fuel, as discharged by the fuel pump 13, is fed to the common rail 15. The common rail 15 stores the fuel at a controlled high pressure and supplies it to the fuel injectors 17 through high-pressure fuel paths 16, respectively. The fuel injectors, as illustrated in FIG. 1, are installed one in each of four cylinders of the diesel engine. An excess of the fuel having entered each of the fuel injectors 17 is drained to the fuel tank 11 through a low-pressure fuel path 18.

The fuel injection system also includes a crank angle sensor 19, an accelerator position sensor 20, or the like to monitor operating conditions of the diesel engine. The crank angle sensor 19 works to measure the angular position of the crankshaft 14. The accelerator position sensor 20 works to measure the position of an accelerator pedal as a function of a driver's effort on the accelerator pedal (i.e., a driver's request to accelerate the diesel engine). Outputs of these sensors are inputted to an electronic control unit (ECU) 30.

The ECU 30 is implemented by a typical microcomputer and works to analyze outputs from the sensors 19 and 20 to control an output of the diesel engine. The ECU 30 basically controls the output from the diesel engine as a function of the position of the accelerator pedal. When the accelerator pedal is released fully, the ECU controls the diesel engine in a known ISC (Idle Speed Control) feedback mode to bring the speed of the crankshaft 14 into agreement with a target value to stabilize the operation of the diesel engine.

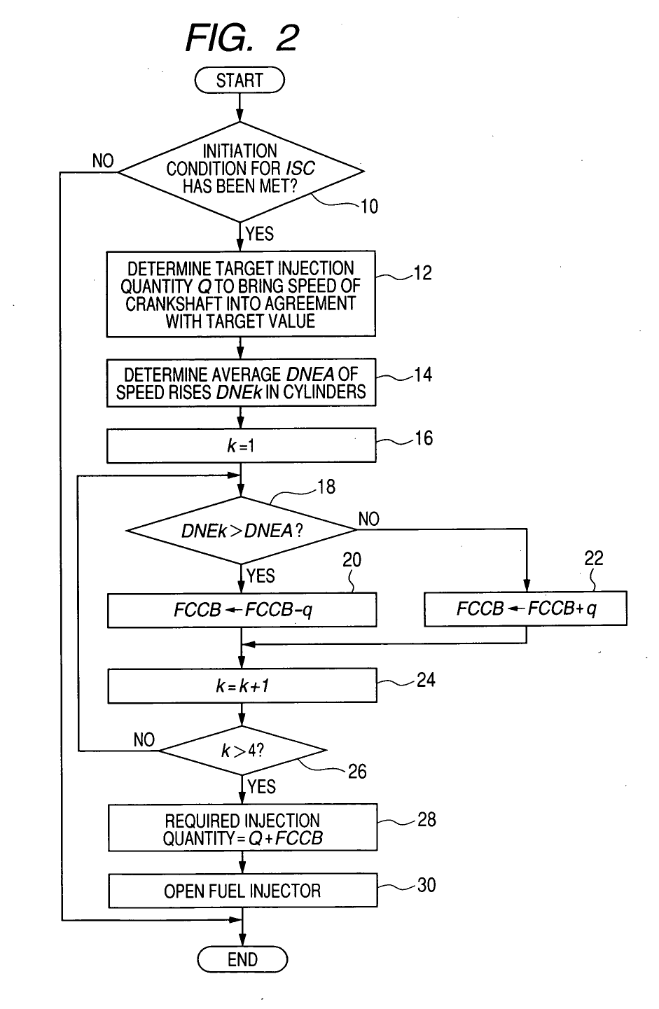

FIG. 2 is a flowchart of an ISC program to be executed by the ECU 30 at a regular time interval (e.g., an operating cycle of the microcomputer or a given angular interval of rotation of the crankshaft 14).

After entering the program, the routine proceeds to step 10 wherein conditions to initiate the ISC feedback mode have been met or not. For instance, when the output from the accelerator position sensor 20 indicates that the accelerator pedal is released fully, and an output from a vehicle speed sensor indicates that the speed of the vehicle is zero (0), so that the vehicle is stopped, a YES answer is obtained in step 10.

The routine then proceeds to step 12 wherein a target quantity of fuel (will also be referred to as an injection quantity Q below) to be sprayed into the diesel engine for bringing the speed of the crankshaft 14 into agreement with a target idling speed in the feedback mode is determined. The injection quantity Q is given by the sum of a basic quantity of fuel that is defined as a feedforward term required to bring the speed of the crankshaft 14 toward the target idling speed and a quantity of fuel (will also be referred to as a feedback correction quantity QISC below) that is defined as a correction factor required to compensate for a difference between the target idling speed and an actual speed of the crankshaft 14, as determined using the output of the crank angle sensor 19.

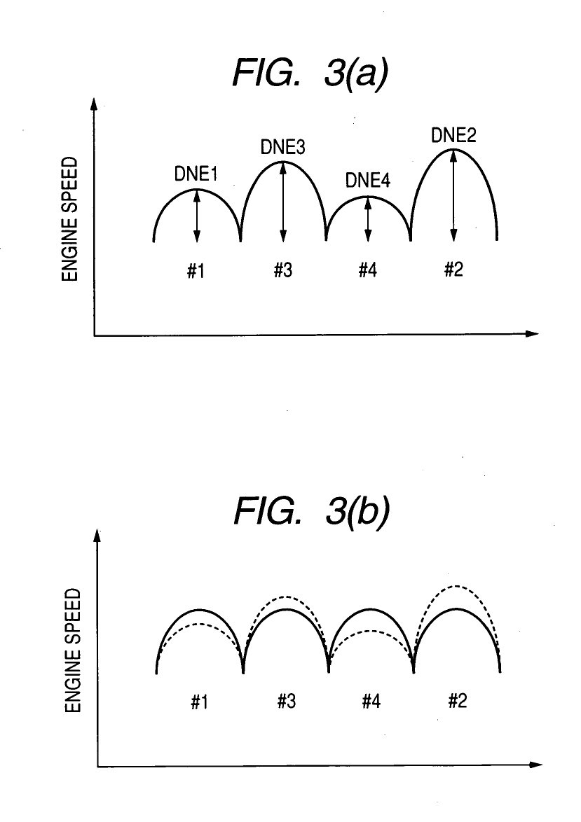

The following steps 14 to 26 work to smooth the speed of the crankshaft 14. Usually, the speed of the crankshaft 14, as demonstrated in FIG. 3(a), rises instantaneously and sequentially in synchronization with injections of fuel into the cylinders #1, #3, #4, and #2 of the diesel engine, and the degree of such speed rise varies among the cylinders #1 to #4. In order to eliminate such a speed variation, the steps 14 to 26 smooth the speed of the crankshaft 14.

In step 14, an average DNEA of sequential rises DNEk in speed of the crankshaft 14 appearing in synchronization with the injections of the fuel into the cylinders #1 to 1#4 is deterred. Each of the speed rises DNEk, as illustrated by a vertical arrow in FIG. 3(a), is a difference between a minimum value of the speed of the crankshaft 14 immediately before it rises synchronously with the injection of the fuel into a corresponding one of the cylinders #1 to #4 and a maximum value of the speed of the crankshaft 14 when it reaches a maximum after rising.

After the average DNEA is calculated, the routine proceeds to steps 16 to 26 to increase or decrease correction factors FCCB used to smooth variations in speed of the crankshaft 14 among the cylinders #1 to #4 based on differences between the speed rises DNEk and the average DNEA. Specifically, in step 16, a cylinder number parameter k is set to one (1) which indicates one of the cylinders of the diesel engine to be selected. The routine proceeds to step 18 wherein it is determined whether one of the speed rises DNEk, as represented by the cylinder number parameter k, is greater than the average DNEA or not. If a YES answer is obtained (DNEk>DNEA), then the routine proceeds to step 20 wherein one of the correction factors FCCB, as selected currently, is decreased by a given value q. Alternatively, if a NO answer is obtained, then the routine proceeds to step 22 wherein the selected one of the correction factors FCCB is increased by the given value q. If the one of the speed rises DNEk is substantially identical with the average DNEA, the correction factor FCCB is not corrected.

After step 20 or 22, the routine proceeds to step 24 wherein the cylinder number parameter k is incremented by one (1). The routine proceeds to step 26 wherein it is determined whether the cylinder number parameter k is greater than four (4) or not. If a NO answer is obtained, then the routine returns back to step 18 to determine whether a subsequent one of the speed rises DNEk is greater than the average DNEA or not.

Specifically, after the correction factors FCCB for all the four cylinders #1 to #4 are corrected, the routine proceeds to step 28 wherein the quantity of fuel (as will also be referred to as a commanded injection quantity of fuel below) required to be sprayed from each of the fuel injectors 17 in an engine combustion cycle (i.e., a four-stroke cycle) including intake or induction, compression, expansion, and exhaust is given by the sum of the injection quantity Q, as described above, and a corresponding one of the correction factor FCCB. The ECU 30 actuates the fuel injectors 17 in sequence to spray the required quantity of fuel, as determined in the above manner, thereby minimizing the variations in speed of the crankshaft 14 among the cylinders #1 to #4, as illustrated in FIG. 3(b).

The ECU 30 outputs a drive pulse signal (as will also be referred to as an injection command pulse signal below) to each of the fuel injectors 17. Each of the fuel injectors 17 has installed therein a lift mechanism equipped with a valve actuator such as an electromagnetic solenoid or a piezoelectric device which is driven or energized to open a spray hole for a period of time (i.e., an injection duration) defined by the width of the drive pulse signal and is denergized to close the spray hole when the drive pulse signal falls In step 30, the ECU 30 outputs the drive pulse signal to each of the fuel injectors 17 to spray the commanded injection quantity of fuel, as determined in step 28.

If the fuel injectors 17 are operating properly, the commanded injection quantity of fuel, as determined in step 28, will be sprayed actually into the diesel engine. If a NO answer is obtained in step 10 meaning that the conditions to initiate is program are not yet met, or after step 30, the routine terminates. As apparent from the above discussion, the ISC program works to keep the speed of the crankshaft 14 at the target idling speed during idle modes of engine operation accurately.

Usually, the fuel injectors 17 may be clogged with foreign objects contained in the fuel, which results in a failure in operation of a lift mechanism to open or close the spray hole. Foreign objects may also be deposited to the spray hole of the fuel injectors 17, which results in spraying of no fuel or a lack of quantity of fuel sprayed.

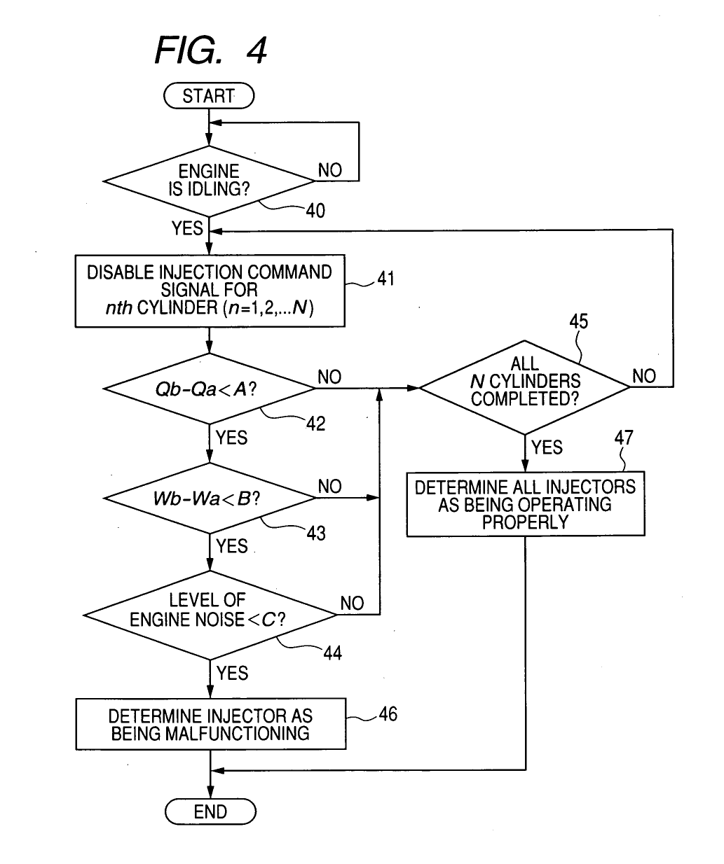

FIGS. 4 to 6 represent how to monitor the above malfunction (i.e., no fuel-injection failure in this embodiment) of each of the fuel injectors 17.

The monitoring of the malfunction of the fuel injectors 17 is to be made at motor vehicle workshops of dealers, for example, using an external service tool 40 which serves as a diagnostic device.

The automobile equipped with this fuel injection system is first placed in the idle mode of the engine operation at the workshops The ECU 30 then initiates the ISC program, as shown in FIG. 2. An operator connects the service tool 40 to the ECU 30. The service tool 40 is made of a microcomputer and establishes bi-directional communication with the ECU 30 upon the connection to the ECU 30.

Next, the operator turns on the service tool 40 to commence the monitoring of the malfunction of the fuel injectors 17. The microcomputer of the service tool 40 then initiates a malfunction monitoring program, as illustrated in FIG. 4, at a regular time interval (e.g., an operating cycle of the microcomputer or a given angular interval of rotation of the crankshaft 14).

First, in step 40, it is determined whether the diesel engine is in the idle mode or not. Specifically, the information about the determination in step 10 of FIG. 2 of whether the conditions to initiate the ISC program have been met or not is obtained from the ECU 30. The microcomputer of the service tool 40 analyzes such information to determine whether the diesel engine is now idling or not. If a YES answer is obtained meaning that the diesel engine is idling, then the routine proceeds to step 41 wherein the injection command pulse signal, as outputted to one of the fuel injectors 17 selected in this program cycle, is disabled to place the selected fuel injector 17 in a non-injection mode. Specifically, the injection command pulse signal outputted from the ECU 30 to the electromagnetic solenoid of the selected one of the fuel injectors 17 is blocked to inhibit that fuel injector 17 from spraying the fuel.

The placement of the fuel injector 17 in the non-injection mode may alternatively be achieved by outputting a stop signal from the service tool 40 to the ECU 30 to stop outputting the injection command pulse signal.

In the case where the fuel injector 17 which is operating properly is placed in the non-injection mode, it wig cause the fuel to be stopped from being sprayed suddenly during the idling of the diesel engine, thus resulting in a great change in content of a control task for or in controlled operating condition of the diesel engine. Alternatively, in the case where the fuel injector 17 which is malfunctioning so that it is spraying no fuel or failing to spray the fuel is placed in the non-injection mode, it will result in no change in content of the control task or controlled operating condition of the diesel engine.

In the view of the above fact, following steps 42, 43, and 44, as will be described later in detail, determine whether the content of the control task or the controlled operating condition of the diesel engine has been changed or not due to the placement of the fuel injector 17 in the non-injection mode. If it is determined that there is no change in content of the control task or controlled operating condition of the diesel engine, step 46 determines that the selected one of the fuel injectors 17 which is placed in the non-injection mode is malfunctioning. The microcomputer of the service tool 40 outputs a diagnosis signal indicating such a malfunction of the selected one of the fuel injectors 17 and turn on an injection failure diagnosis flag.

If it is determined that there is a change in content of the control task or controlled operating condition of the diesel engine, then the routine proceeds to step 45 wherein it is determined whether all the fuel injectors 17 have been placed in the non-injection mode in step 41 or not. If a NO answer is obtained, then the routine returns back to step 41 wherein a subsequent one of the fuel injectors 17 is placed in the non-injection mode. If the content of the control task or the controlled operating condition of the diesel engine is determined to have been changed (i.e., a NO answer is obtained in step 42, 43, or 45), and all the fuel injectors 17 are determined to have been already placed in the non-injection mode (i.e., a YES answer is obtained in step 45), the routine proceeds to step 47 wherein all the fuel injectors 17 are determined not to be placed in the injection failure condition. The microcomputer of the service tool 40 then outputs We diagnosis signal indicating that all the fuel injectors 17 are operating properly.

Step 42 monitors a change in the commanded injection quantity of fuel. Step 43 monitors a change in speed of the diesel engine. Step 44 monitors an operating noise (i.e., combustion noise) of the diesel engine. These parameters are used as representing a change in state of the diesel engine. The operations in steps 42, 43, and 44 will be described below in detail.

step 42: Monitoring Change in Quantity of Fuel to be Sprayed

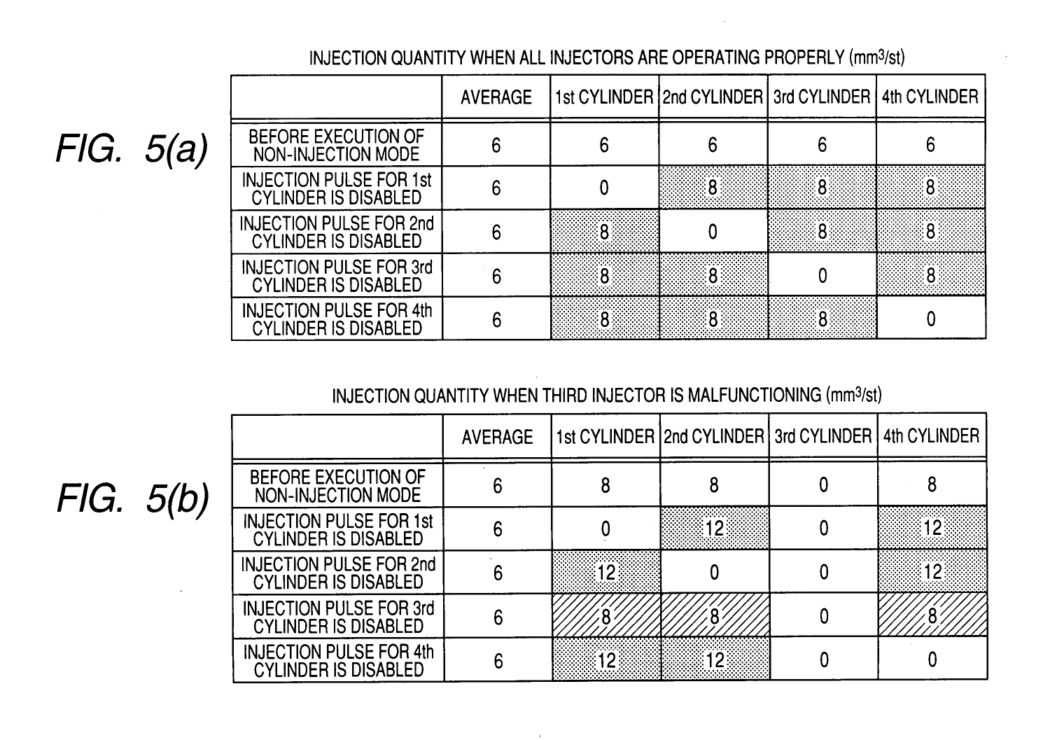

FIGS. 5(a) and 5(b) are tables which demonstrate changes in quantity of fuel sprayed from the fuel injectors 17 for a duration in which the lift mechanism experiences a stroke to open the spray hole once between before and after the non-injection mode is entered.

FIG. 5(a) illustrates the case where the four fuel injectors 17 are all operating properly. The commanded injection quantity of fuel to be sprayed by each of the fuel injectors 17 is 6 mm³/st. The quantity of fuel actually sprayed from each of the fuel injectors 17 before the non-injection mode is entered will, therefore, be 6 mm³/st. When the injection command pulse signal is disabled to place the fuel injector 17 for the first cylinder #1 in the non-injection mode, an output of the diesel engine drops by an amount corresponding to 6 mm³/st so that the speed of the diesel engine will decrease. The ISC program of FIG. 2 immediately increases the commanded injection quantity of fuel to be sprayed from the fuel injector 17 from 6 mm³/st to 8 mm³/st in step 28 so as to compensate for the decrease in idle speed of the diesel engine. Since the fuel injector 17 for the first cylinder #1 is stopped from spraying the fuel, a total quantity of fuel to be sprayed from the fuel injectors 17 for the second to fourth cylinders #2 to #4 will compensate for the quantity of fuel the fuel injector 17 for the first cylinder #1 has been stopped from spraying, so that an average of quantities of fuel sprayed actually from all the fuel injectors 17 will be kept at 6 mm³/st.

Similarly, when the fuel injectors 17 for the second to fourth cylinders #2, #3, and #4 are placed in sequence in the non-injection mode, the commanded injection quantity of fuel to be sprayed from each of all the fuel injectors 17 is changed from 6 mm³/st to 8 mm³/st. The quantity of fuel actually sprayed from each of the fuel injectors 17 not placed in the non-injection mode will be 8 mm³/st. Specifically, when one of the fuel injectors 17 is placed in the non-injection mode, it will cause the commanded injection quantity of fuel to be increased. If, in step 42, it is determined that the commanded injection quantity has been increased, that is, a NO answer is obtained, it is concluded that the content of the engine control task has been changed due to the execution of the non-injection mode.

Specifically, in step 42, it is determined whether Qb minus Qa is smaller than a given value A or not, “Qa” represents the commanded injection quantity as read in the service tool 40 before the non-injection mode is entered “Qb” represents the commanded injection quantity as read in the service tool 40 when the non-injection mode is entered. If a difference (Qb−Qa) is greater than the given value A, the service tool 40 determines that the fuel injector 17 placed in the non-injection mode is operating properly.

In the case, as demonstrated in FIG. 5(b), where one of the fuel injectors 17 for the third cylinder #3 is malfunctioning so that no fuel is being sprayed. The ISC program of FIG. 2 increases the commanded injection quantity of fuel required to be sprayed from each of the fuel injectors 17 from 6 mm³/st to 8 mm³/st so as to compensate for the quantity of fuel the fuel injector 17 for the third cylinder #1 has not sprayed, so that an average of quantities of fuel sprayed actually from all the fuel injectors 17 will be, like in FIG. 5(a), kept at 6 mm³/st.

When the ECU 30 determines, as described above, the commanded injection quantity so as to compensate for the quantity of fuel the malfunctioning fuel injector 17 is required to spray, and the injection command pulse signal to be outputted to the fuel injector 17 for the first cylinder #1 is disabled to place that fuel injector 17 in the non-injection mode, it will cause the output of the diesel engine to drop immediately by an amount corresponding to 8 mm³/st, so that the speed of the diesel engine decreases. The ISC program of FIG. 2 increases the commanded injection quantity of fuel to be sprayed from the fuel injector 17 from 8 mm³/st to 12 mm³/st in step 28 so as to compensate for the decrease in idle speed of the diesel engine. Specifically, the commanded injection quantity of fuel required to be sprayed from the fuel injectors 17 is so determined as to compensate for the sum of the quantity of fuel not having been sprayed from the fuel injector 17 for the first cylinder #1 placed in the non-injection mode and the quantity of fuel the fuel injector 17 for the third cylinder #3 has failed to spray. The average of quantities of fuel sprayed from all the fuel injectors 17 will, therefore, be kept at 6 mm³/st.

When the fuel injector 17 for the third cylinder #3 is placed in the non-injection mode, it means that the injection command pulse signal to be outputted to the fuel injector 17 being now failing to spray the fuel is disabled. The commanded injection quantity will, therefore, not be changed before and after the non-injection mode is entered, so that it is kept at 8 mm³/st (see hatched areas in FIG. 5(b)). If such a condition is encountered, it is concluded that the commanded injection quantity is not changed. A YES answer is, therefore, obtained in step 42 meaning that the content of the engine control task is not changed by the execution of the non-injection mode. Specifically, if the difference Qb−Qa is smaller than the given value A in step 42, the fuel injector 17 having been placed in the non-injection mode when the content of the engine control task is not changed is determined as being malfunctioning, so that no fuel is being sprayed.

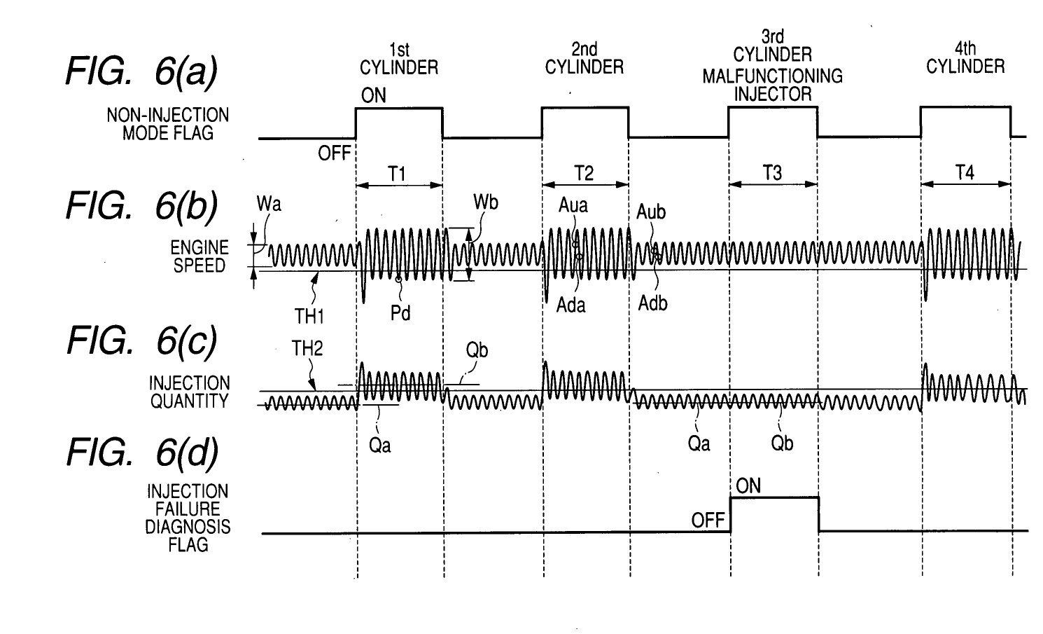

FIGS. 6(a) to 6(d) illustrate a non-injection mode flag, a variation in speed of the diesel engine, a change in quantity of fuel sprayed from the fuel injectors 17, and the injection failure diagnosis flag in the example of FIG. 5(b). The fuel injectors 17, as indicated by the non-injection mode flag in FIG. 6(a), are placed in sequence in the non-injection mode for flag-on durations T1, T2, T3, and T4, respectively. The length of time the non-injection mode continues to be executed is selected to be longer than the engine combustion cycle, in other words, the injection command pulse signal to be outputted to each of the fuel injectors 17 is disabled several times for one of the flag-on durations T1, A2, T3, and T4. FIG. 6(b) represents a variation in speed of the diesel engine arising from the execution of the non-injection mode. FIG. 6(c) represents a change in quantity of fuel sprayed from the fuel injectors 17. FIG. 6(d) represents the status of the injection failure diagnosis flag, as set in step 46 of FIG. 4. Pulsations, as appearing in FIG. 6(b), represent instantaneous variations in speed of the diesel engine. The speed of the diesel engine rises during the expansion stroke of the piston in each of the cylinders and drops during other strokes thereof. Pulsations in FIG. 6(c) appear synchronously with the variations in speed of the diesel engine, as illustrated in FIG. 6(b).

As can be seen from FIG. 6(c), the injection quantity of fuel sprayed from the fuel injectors 17 for each of the durations T1, T2, and T4 in which the fuel injectors 17 for the first, the second, and the fourth cylinders #1, #2, and #4 are placed in the non-injection mode is increased to Qb from Qa which has been sprayed before the entry of the non-injection mode. In contrast, the injection quantity Qb of fuel sprayed from the fuel injectors 17 for the duration T3 in which the fuel injector 17 for the third cylinder #3 is placed in the non-injection mode is not changed from the injection quantity Qa of fuel sprayed before the entry of the non-injection mode. The injection quantities Qa and Qb indicate an average of the pulsating quantities of fuel in FIG. 6(c).

In step 42, the determination may alternatively be made based on an absolute value of the injection quantity Q during the execution of the non-injection mode. For instance, when the absolute value of the injection quantity Qb has exceeded a given threshold TH2, as indicated in FIG. 6(c), due to the execution of the non-injection mode, it may be determined that the injection quantity of fuel sprayed from the fuel injectors 17 has been changed

### Step 43: Monitoring Change in Speed of Engine

When the fuel injectors 17 which are operating properly are placed in the non-injection mode, it will result in an increase in variation in sprayed quantity of fuel among the cylinders, which leads to, as can be seen in FIG. 6(b), a great change in speed of the diesel engine during each of the durations T1, T2, and T4, while when the fuel injector 17 which is malfunctioning is placed in the non-injection mode, it will result in no change in variation in sprayed quantity of fuel among cylinders, so that the instantaneous variation in speed of the diesel engine for the duration T3 is not changed from that immediately before the duration T3.

In view of the above fact, step 43 determines whether a difference between the amplitude Wa of the variation in speed of the diesel engine before the injection command pulse signal is disabled and the amplitude Wb of that when the injection command pulse signal is disabled (i.e., Wb−Wa) is smaller than a given value B or not. If, in step 43, it is determined the difference Wb−Wa is greater than or equal to the given value B, that is, a NO answer is obtained, it is concluded that the speed of the diesel engine has been changed meaning that the operating condition of the diesel engine has been changed due to the execution of the non-injection mode. Alternatively, if it is determined in step 43 that the difference Wb−Wa is smaller than the given value B, that is a YES answer is obtained, it is concluded that the speed of the diesel engine has not been changed due to the execution of the non-injection mode.

The determination in step 43 may alternatively be made whether a lower value (i.e., a minimum value) of the speed of the diesel engine which is varying due to the execution of the non-injection mode is, as illustrated in FIG. 6(b), decreased below a given threshold TH1. If such an event is encountered, it may be determined that the amplitude of the variation in speed of the diesel engine has changed.

When the fuel injectors 17 which are operating properly are placed in the non-injection mode, so that a variation in sprayed quantity of fuel among the cylinders of the diesel engine increases, it will cause the rate of variation in speed of the diesel engine to increase as well as an increase in the amplitude Wb of the variation in speed of the diesel engine. Specifically, an absolute value of an inclination Aua or Aub, as illustrated in FIG. 6(b), at which the speed of the diesel engine rises and an absolute value of an inclination Ada or Adb at which the speed of the diesel engine drops increase. When the fuel injector 17 which is malfunctioning is placed in the non-injection mode, the variation in sprayed quantity of fuel among the cylinders, as described above, is not changed, thus resulting in no change in the inclination Aud, Aub, Ada, or Adb.

In view of the above fact, step 43 may calculate an average of absolute values of the inclinations Aud, Aub, Ada, and Adb and determine that the speed of the diesel engine has been changed due to the execution of the non-injection mode (i.e., a NO answer is obtained) when the average has been increased. Alternatively, when the average has not been changed, step 43 may determine that the operating condition of the diesel engine is not changed due to the execution of the non-injection mode.

### Step 44: Monitoring Change in Engine Noise

When the fuel injectors 17 which are operating properly are placed in the non-injection mode, so that the variation in sprayed quantity of fuel among the cylinders increases, the pulsations of the speed of the diesel engine) as described above, increase, thus resulting in an increase in operating noise of the diesel engine. Additionally, an increase in quantity of fuel sprayed into one of the cylinders of the diesel engine will result in an increase in combustion noise arising from the burning of the fuel within the one of the cylinders. When the fuel injector 17 which is malfunctioning is placed in the non-injection mode for the duration T3, the variation in sprayed quantity of fuel among the cylinders is, as described above, not changed, thus causing the operating noise and combustion noise (which will be generally referred to as engine noise below) not to be changed from those before the duration T3.

In view of the above fact, step 44 determines whether a change in level of the engine noise, as measured by a sound level sensor (not shown), is less than a given value C or not. If a NO answer is obtained meaning that the change in level of the engine noise greater than the given value C has occurred due to the execution of the non-injection mode, in other words, that the operating condition of the diesel engine has been changed due to the execution of the non-injection mode. If a YES answer is obtained meaning that the engine noise is not changed, it is concluded that the operating condition of the diesel engine has not been changed due to the execution of the non-injection mode.

If YES answers are obtained all in steps 42, 43, and 44 meaning that the operating conditions of the diesel engine are not changed, the routine proceeds to step 46 wherein a selected one of the fuel injectors 17 is malfunctioning, so that no fuel is being sprayed. Alternatively, if a YES answer is obtained in at least one of steps 42, 43, and 44, it may be determined that the selected one of the fuel injectors 17 is malfunctioning. Any one of steps 42, 43, and 44 may be omitted.

The injector malfunction monitoring system, as described above, offers the following beneficial effects.
1) The fuel injectors 17 are placed in sequence in the non-injection mode to monitor a change in state of the diesel engine. When such a state change is found to have occurred when one of the fuel injectors 17 is placed in the non-injection mode, the injection malfunction monitoring system determines that the one of the fuel injectors 17 is operating properly. Alternatively, when the state change is not found, the injection malfunction monitoring system determines that the one of the fuel injectors 17 is malfunctioning. When the fuel injector 17 which is operating properly is placed in the non-injection mode, it will result in a great change in state of the diesel engine, while when the fuel injector 17 which is malfunctioning is placed in the non-injection mode, it will result in almost no change in state of the diesel engine, thereby improving the accuracy in diagnosing the fuel injectors 17.
2) The length of time (i.e., the flag-on durations T1, T2, T3, and T4) the non-injection mode continues to be executed is, as described above, selected to be longer than the engine combustion cycle, so that the injection command pulse signal to be outputted to each of the fuel injectors 17 is disabled several times for each of the flag-on durations T1, T2, T3, and T4. This will cause the change in state of the diesel engine when the fuel injector 17 which is operating properly is placed in the non-injection mode to appear greatly as compared with when the injection command pulse signal is disabled only for the engine combustion cycle, thus increasing the accuracy in diagnosing the fuel injectors 17.
3) The diagnosis of the fuel injectors 17 is, as described above, made when the diesel engine is idling. In other words, the malfunctioning of the fuel injectors 17 is monitored when the speed of the diesel engine is low, thus keeping the working environment quiet at the motor vehicle workshop.

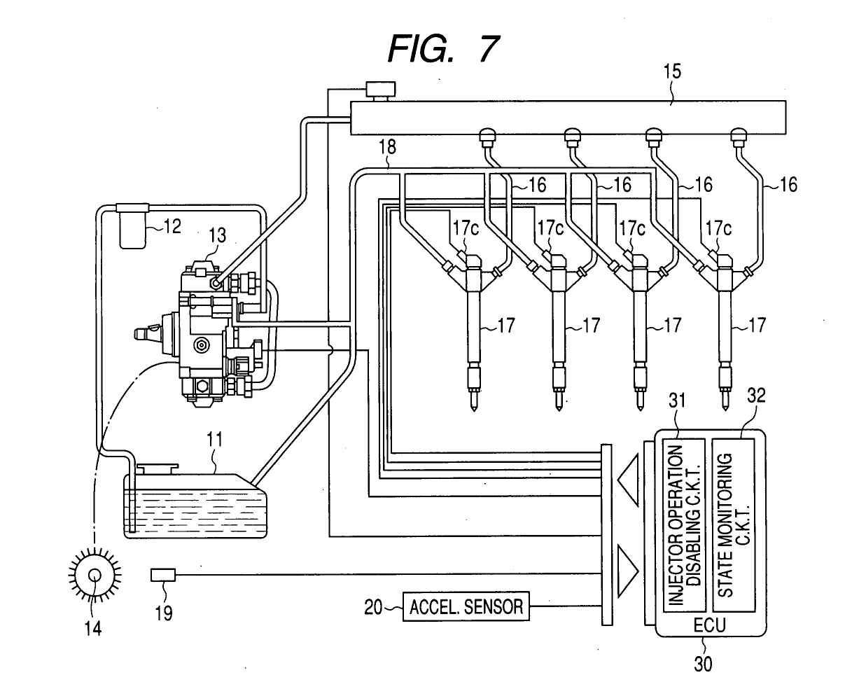

FIG. 7 illustrates a fuel injection system according to the second embodiment of the invention.

The diagnosis of the fuel injectors 17 in the first embodiment is, as described above, made at motor vehicle workshops of dealers using the external service tool 40. Specifically, the service tool 40 works in step 41 of FIG. 4 to perform an injector operation disabling function to disable the injection command pulse signal to place the fuel injectors 17 in the non-injection mode, in steps 42, 43, and 44 to perform a state monitoring function to monitor a change in state of the diesel engine, and in step 46 or 47 to perform a diagnosis function to diagnose whether the fuel injectors 17 are malfunctioning or not.

The fuel injection system of this embodiment is designed to perform an injector malfunction monitoring function in itself. Specifically, the ECU 30 diagnoses the fuel injectors 17 automatically while the operator is driving the vehicle equipped with is system. The ECU 30 has installed therein an injector operation disabling circuit 31, a state monitoring circuit 32, and a diagnosis circuit and works to initiate the malfunction monitoring program of FIG. 4 in response to turning on of an ignition switch of the vehicle. This also offers an additional advantage 4) of eliminating the need for bringing the vehicle to the workshop. The use of the service tool 4, however, has the advantage that it is possible to diagnose the fuel injection system which is, like in the first embodiment, designed not to execute the malfunction monitoring program of FIG. 4 in the ECU 30.

The ECU 30 of the second embodiment may alternatively be designed to have only one or two of the injector operation disabling circuit 31, the state monitoring circuit 32, and the diagnosis circuit on the condition that the service tool 40 is designed to have the other or others of the injector operation disabling circuit 31, the state monitoring circuit 32, and the diagnosis circuit.

The third embodiment of the invention will be described below.

The first embodiment is designed to perform the non-injection mode when the diesel engine is idling. The third embodiment is designed to perform the non-injection mode when a during-deceleration fuel spraying smoothing operation is being executed and to have the same structure as illustrated in FIG. 7. Specifically, the ECU 30 diagnoses the fuel injectors 17 automatically while the vehicle equipped with this system is running.

When the vehicle operator is releasing the accelerator pedal to decelerate the diesel engine, the during-deceleration fuel spraying smoothing operation is initiated by the ECU 30 to decrease a target quantity of fuel to be sprayed from each of the fuel injectors 17 gradually at a given rate. Specifically, the quantity of fuel sprayed from the fuel injectors 17 is decreased slowly without cutting the supply of fuel to the diesel engine suddenly after the accelerator pedal is released, thereby minimizing an uncomfortable shock arising from the sudden deceleration of the diesel engine.

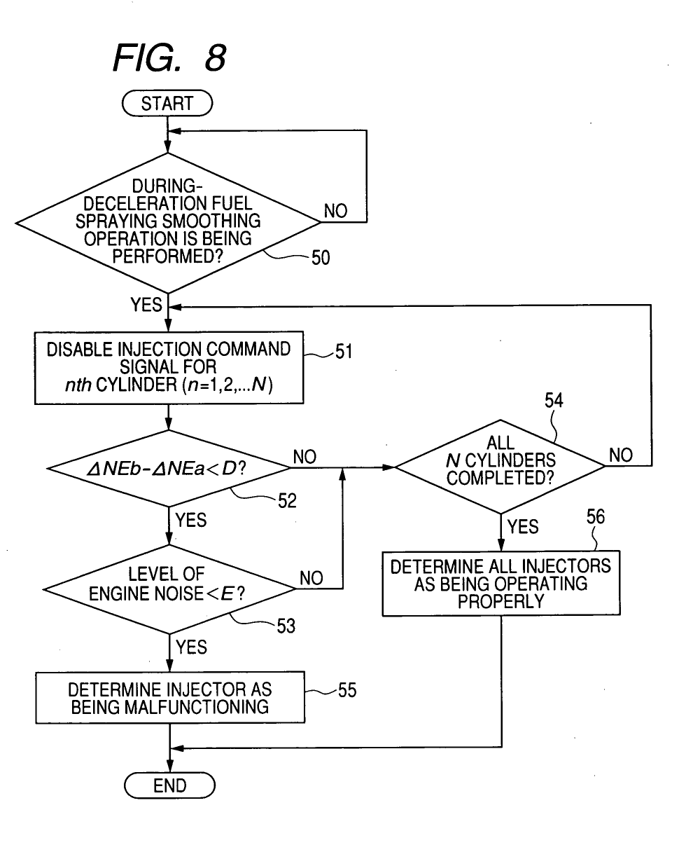

The ECU 30 is equipped with the injector operation disabling circuit 31 and the state monitoring circuit 32 and works to perform a malfunction monitoring program of FIG. 8 at a regular time interval (e.g., an operating cycle of the microcomputer of the ECU 30 or a given angular interval of rotation of the crankshaft 14) in response to turning on of the ignition switch.

First, in step 50, it is determined whether the during-deceleration fuel spraying operation is being executed or not. If a YES answer is obtained, then the routine proceeds to step 51 wherein the injection command pulse signal, as outputted to one of the fuel injectors 17 selected in this program cycle, is disabled, like in step 41 of FIG. 4, to place the selected one of the fuel injectors 17 in the non-injection mode.

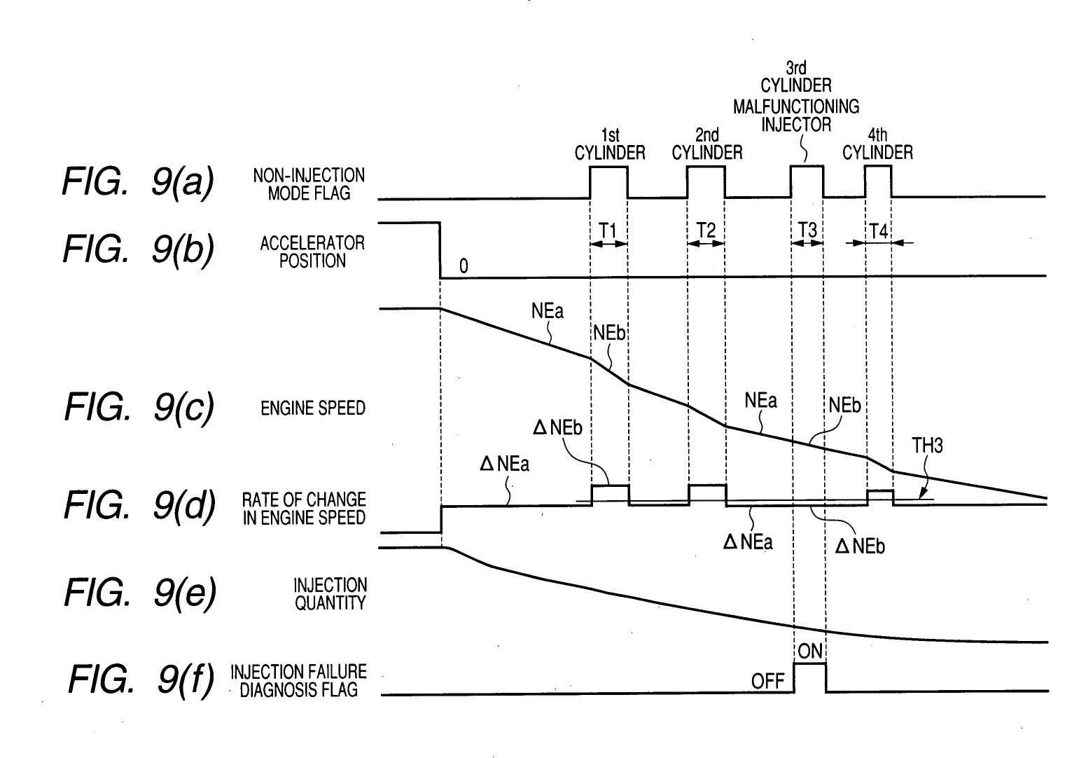

When the fuel injector 17 which is operating properly is placed in the non-injection mode, it will cause the fuel to be stopped from being sprayed suddenly, thus resulting in a rapid drop in speed of the diesel engine (see Neb during the flag-on duration T1 in FIG. 9(c)). When the fuel injector 17 which is malfunctioning so that it is spraying no fuel is placed in the non-injection mode, it means that the injection command pulse signal to be outputted to the fuel injector 17 being now failing to spray the fuel is disabled, thus resulting in no change in rate at which the speed of the diesel engine drops (see Neb during the flag-on duration T3 in FIG. 9(c).

In the view of the above fact, following steps 52 and 53, as will be described later in detail, determine whether the content of the control task or the controlled operating condition of the diesel engine has been changed or not due to the placement of the fuel injector 17 in the non-injection mode. If it is determined in step 52 or 53 that there is no change in content of the control task or controlled operating condition of the diesel engine, step 55 determines that the selected one of the fuel injectors 17 which is placed in the non-injection mode is malfunctioning. The ECU 30 outputs a diagnosis signal indicating such a malfunction of the selected one of the fuel injectors 17 and turn on an injection failure diagnosis flag.

Alternatively, if it is determined that there is a change in content of the control task or controlled operating condition of the diesel engine, then the routine proceeds to step 54 wherein it is determined whether all the fuel injectors 17 have been placed in the non-injection mode in step 51 or not. If a NO answer is obtained, then the routine returns back to step 51 wherein a subsequent one of the fuel injectors 17 is placed in the non-injection mode. If the content of the control task or the controlled operating condition of the diesel engine is determined to have been changed (i.e., a NO answer is obtained in step 52 or 53), and all the fuel injectors 17 are determined to have been already placed in the non-injection mode (i.e., a YES answer is obtained in step 54), the routine proceeds to step 56 wherein all the fuel injectors 17 are determined not to be placed in the injection failure condition. The ECU 30 then outputs the diagnosis signal indicating that all the fuel injectors 17 are operating properly.

Step 52 monitors a change in rate at which the speed of the diesel engine drops. Step 53 monitors the operating noise (i.e., combustion noise) of the diesel engine. These parameters are used as representing a change in state of the diesel engine. The operations in steps 52 and 53 will be described below in detail.

Step 52: Monitoring Change in Rate at which Engine Speed Drops

Step 52 determines whether the rate of change in speed of the diesel engine has been changed arising from the execution of the non-injection mode or not. If the rate of change is determined to have been changed (i.e., a NO answer is obtained), it is concluded that the operating condition of the diesel engine has been changed due to the execution of the non-injection mode. Specifically, it is determined in step 52 whether a difference ΔNEb−ΔNEa is smaller than a given value D or not. “ΔNEb” represents the rate of change in speed of the diesel engine before the execution of the non-injection mode. “ΔNEd” represents the rate of change in speed of the diesel engine upon the execution of the non-injection mode. If a NO answer is obtained meaning that the difference ΔNEb−ΔNEa is greater than the given value D, it is determined that the fuel injector 17 placed in the non-injection mode is operating properly.

If a NO answer is obtained meaning that the difference ΔNEb−ΔNEa is smaller than the given value D, it is determined that the operating condition of the diesel engine has not been changed due to the execution of the non-injection mode and that the fuel injector 17 placed in the non-injection mode is malfunctioning.

FIG. 9(a) demonstrates the non-injection mode flag indicating the execution of the non-injection mode. The fuel injectors 17 are placed in sequence in the non-injection mode for flag-on durations T1, T2, T3, and T4, respectively. The length of time the non-injection mode continues to be executed is selected to be longer than the engine combustion cycle, in other words, the injection command pulse signal to be outputted to each of the fuel injectors 17 is disabled several times for one of the flag-on durations T1, T2, T3, and T4. FIG. 9(b) demonstrates the state or position of the accelerator pedal FIG. 9(c) demonstrates a change in speed of the diesel engine. FIG. 9(d) demonstrates a change in rate at which the speed of the diesel engine drops FIG. 9(e) demonstrates the commanded injection quantity. FIG. 9(f) demonstrates the status of the injection failure diagnosis flag, as set in step 55 of FIG. 8. FIG. 9(c) omits pulsations of an instantaneous variation in speed of the diesel engine for the brevity of illustration.

As can be seen from FIGS. 9(b) and 9(e), when the accelerator pedal is released to decelerate the diesel engine, the commanded injection quantity of fuel to be sprayed from the fuel injector 17 us decreased gradually to zero (0) through the during-deceleration fuel spraying smoothing operation in the ECU 30. This causes, as illustrated in FIG. 9(c), the speed of the diesel engine to drop gradually.

When the fuel injector 17 for the first cylinder #1 is placed in the non-injection mode for the duration T1 during the execution of the during-deceleration fuel spraying smoothing operation, the speed of the diesel engine will be changed to NEb from NEa that is the speed of the diesel engine before the entry of the non-injection mode. The rate of change in speed of the diesel engine, therefore, increases from ΔNEa to ΔNEb, as illustrated in FIG. 9(d). The same applies to the durations 12 and 74 in which the fuel injectors 17 for the second and fourth cylinders #2 and #4 are placed in the non-injection mode. In contrast, when the fuel injector 17 for the third cylinder #3 which is malfunctioning is placed in the non-injection mode for the duration T3, the rates of change ΔNEa and ΔNEb in speed of the diesel engine before and after the execution of the non-injection mode will be the same.

In step 52, the determination may alternatively be made, as illustrated in FIG. 9(d), whether a change in rate at which the speed of the diesel engine drops is greater than a given threshold TH3 or not. If the change in rate exceeds the threshold TH3, it is concluded that the rate of change in speed of the diesel engine has been changed due to the execution of the non-injection mode.

### Step 53: Monitoring Change in Engine Noise

When the fuel injectors 17 which are operating property are placed in the non-injection mode, so that the variation in sprayed quantity of fuel among the cylinders increases, the pulsations of the speed of the diesel engine, as described above, increase, thus resulting in an increase in operating noise of the diesel engine. Additionally, an increase in quantity of fuel sprayed into one of the cylinders of the diesel engine will result in an increase in combustion noise arising from the burning of the fuel within the one of the cylinders. When the fuel injector 17 which is malfunctioning is placed in the non-injection mode for the duration T3, the variation in sprayed quantity of fuel among the cylinders is, as described above, not changed, thus causing the operating noise and combustion noise (i.e., the engine noise) not to be changed from those before the duration T3.

In view of the above fact, step 53 determines whether a change in level of the engine noise, as measured by a sound level sensor (not shown), is less than a given value E or not. If a NO answer is obtained meaning that the change in level of the engine noise greater than the given value E has occurred due to the execution of the non-injection mode, in other words, that the operating condition of the diesel engine has been changed due to the execution of the non-injection mode. If a YES answer is obtained meaning that the engine noise is not changed, it is concluded that the operating condition of the diesel engine has not been changed due to the execution of the non-injection mode.

If YES answers are obtained both in steps 52 and 53 meaning that the operating conditions of the diesel engine are not changed, the routine proceeds to step 55 wherein a selected one of the fuel injectors 17 is malfunctioning, so that no fuel is being sprayed. Alternatively, if a YES answer is obtained in at least one of steps 52 and 53, it may be determined that the selected one of the fuel injectors 17 is malfunctioning. Either of step 52 or 53 may be omitted.

This embodiment also offers an additional advantage 5) of permitting the fuel injectors 17 to be diagnosed through the malfunction monitoring program of FIG. 8 when the diesel engine is not idling.

The ECU 30 of the third embodiment may alternatively be designed to have only one or two of the injector operation disabling circuit 31, the state monitoring circuit 32, and the diagnosis circuit on the condition that the service tool 40 is designed to have the other or others of the injector operation disabling circuit 31, the state monitoring circuit 32, and the diagnosis circuit. For instance, the operator may joint the service tool 40 to the ECU 30 at the workshop of the dealer and operate the part of engine control tasks to be executed in the ECU 30 through the service tool 40 to perform the during-deceleration fuel spraying operation and initiate the malfunction monitoring program of FIG. 8.

The fourth embodiment will be described below.

The first embodiment, as described above, works to place the fuel injectors 17 in the non-injection mode to diagnose them during the idling of the diesel engine. This embodiment is designed to place the fuel injectors 17 in the non-injection mode during execution of an engine speed accelerating operation, as will be described below in detail. The ECU 30, like in the second embodiment, works to perform the injector malfunction monitoring function automatically when the operator is getting on vehicle equipped with this system.

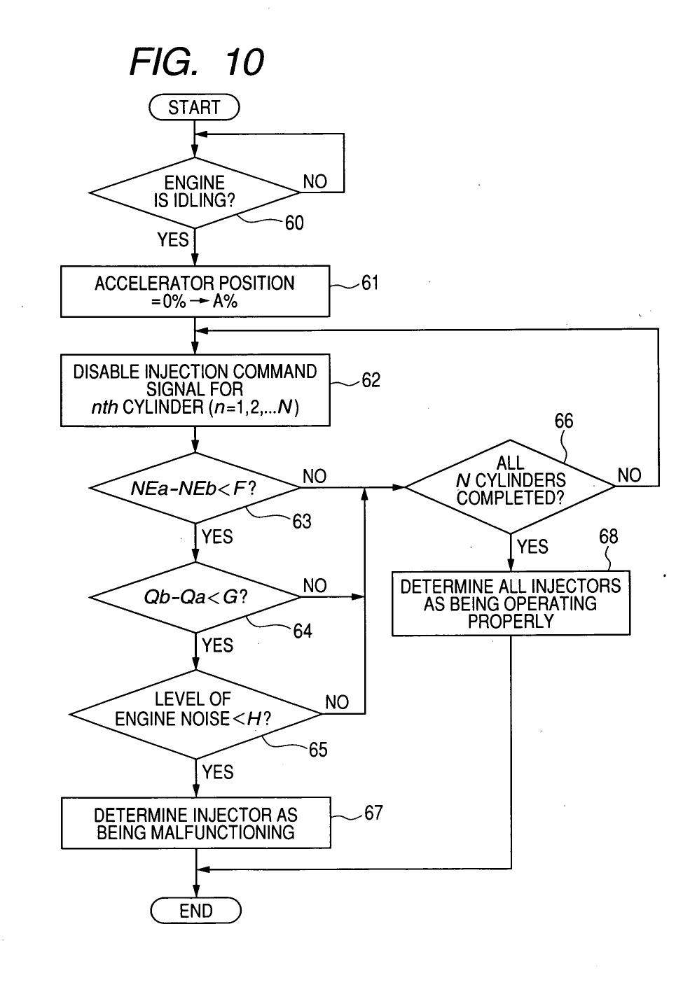

The engine speed accelerating operation is to increase or accelerate the speed of the diesel engine when the operator is releasing the accelerator pedal and parking the vehicle. When the engine speed accelerating operation is performed to automatically create the same condition as that in which the accelerator pedal is depressed, it will cause the conditions to initiate the ISC program of FIG. 2 not to be met in step 10. The diesel engine is forced to be increased in speed without being controlled by the ISC program. The ECU 30 is designed to include the injector-operation disabling circuit 31 and the state monitoring circuit 32 and execute a malfunction monitoring program of FIG. 10 at a regular time interval (e.g., the operating cycle of the microcomputer of the ECU 30 or a given angular interval of rotation of the crankshaft 14) in response to turning on of the ignition switch of the vehicle.

First, in step 60, it is determined whether the diesel engine is in the idle mode under the control of the ISC program of FIG. 2 or not. If a YES answer is obtained, then the routine proceeds to step 61 wherein it is determined whether the position of the accelerator pedal is moved from zero (0) % to a predetermined A percent. Specifically, the engine speed accelerating operation is initiated to move the throttle valve of the diesel engine from a frilly closed position (0%) to a given open position (A %) to accelerate the speed of the diesel engine.

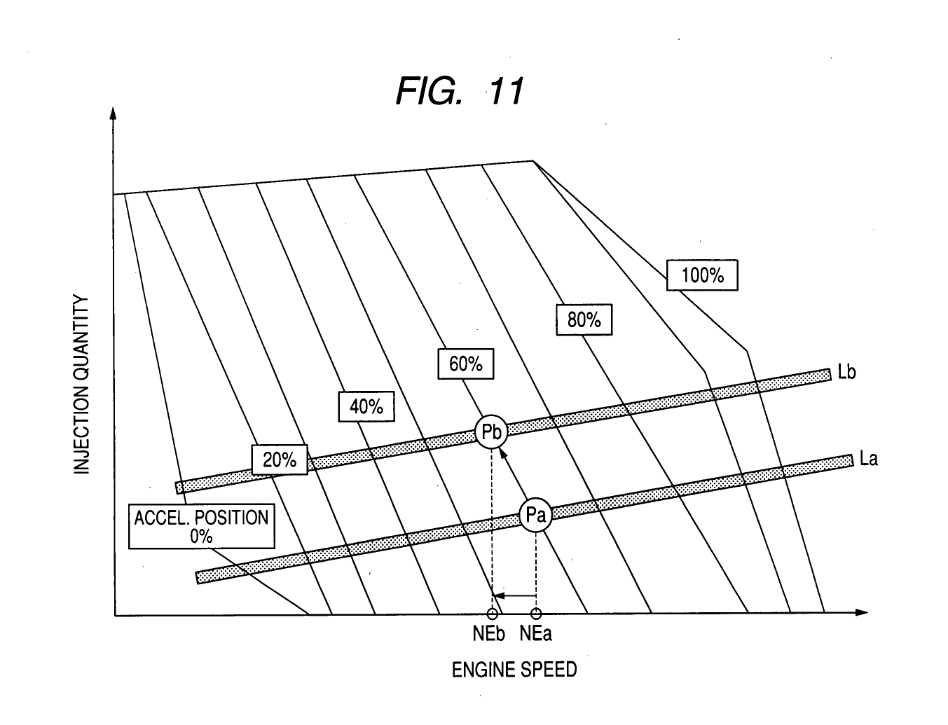

When the ISC program is not executed; the ECU 30 calculates a target quantity (i.e., the commanded injection quantity) of fuel to be sprayed from the fuel injectors 17 based on a required load on and the speed of the diesel engine. The ECU 30 monitors the open position of the throttle valve as a parameter indicating the required load on the diesel engine. FIG. 11 represents a throttle position-engine speed-commanded injection quantity map, as stored in the ROM of the ECU 30. The ECU 30 uses the map to determine the commanded injection quantity of fuel required to be sprayed from each of the fuel injectors 17. Specifically, upon execution of the engine speed accelerating operation in step 61, the ECU 30 deactivates the ISC program of FIG. 2 and sprays the quantity of fuel, as determined using the map of FIG. 11, while the vehicle is being parked.

The routine proceeds to step 62 wherein the injection command pulse signal, as outputted to one of the fuel injectors 17 selected in this program cycle, is disabled to place the selected one of the fuel injectors 17 in the non-injection mode in the manner, as described in step 41 of FIG. 4. For example, when the open position of the throttle valve has been adjusted to 60% (i.e., A %) in step 61, and the speed of the diesel engine is NEa, the ECU 30 determines the commanded injection quantity of fuel to have a value Pa defined on a load balance line La in FIG. 11. When the ECU 30 instructs the fuel injectors 17 to spray the commanded injection quantity Pa of fuel and places one of the fuel injectors which is operating properly in the non-injection mode, it will cause the speed of the diesel engine to be decreased from NEa to NEb by a decrease in total quantity of fuel sprayed into the diesel engine arising from the execution of the non-injection mode. The ECU 30 recalculates the commanded injection quantity of fuel to have a value Pb on a load balance line Lb in FIG. 11 because the open position of the throttle valve remains unchanged. This results in an increase in quantity of fuel sprayed into the diesel engine.

Alternatively, when the fuel injector 17 which is malfunctioning so that it is spraying no fuel is placed in the non-injection mode, it will result in no drop in speed of the engine. The ECU 30 continues to calculate the commanded injection quantity of fuel to have the value Pa on the load balance line La after the non-injection mode is entered.

In the view of the above fact, subsequent steps 63, 64, and 65, as will be described later in detail, determine whether the content of the control task or the controlled operating condition of the diesel engine has been changed or not due to the placement of the fuel injector 17 in the non-injection mode. If it is determined that there is no change in content of the control task or controlled operating condition of the diesel engine, that is, YES answers are obtained I steps 63, 64, and 65, step 67 determines that the selected one of the fuel injectors 17 which is placed in the non-injection mode is malfunctioning. The ECU 30 outputs the diagnosis signal indicating such a malfunction of the selected one of the fuel injectors 17 and turn on the injection failure diagnosis flag.

Alternatively, if it is determined in step 63, 64, or 65 that there is a change in content of the control task or controlled operating condition of the diesel engine, ten the routine proceeds to step 66 wherein it is determined whether all the fuel injectors 17 have been placed in the non-injection mode in step 62 or not. If a NO answer is obtained, then the routine returns back to step 62 wherein a subsequent one of the fuel injectors 17 is placed in the non-injection mode. If the content of the control task or the controlled operating condition of the diesel engine is determined to have been changed (i.e., a NO answer is obtained in step 63, 64, or 65), and all the fuel injectors 17 are determined to have been already placed in the non-injection mode (i.e., a YES answer is obtained in step 66), the routine proceeds to step 68 wherein all the fuel injectors 17 are determined not to be placed in the injection failure condition. The ECU 30 then outputs the diagnosis signal indicating that all the fuel injectors 17 are operating properly.

Step 63 monitors a change in speed of the diesel engine. Step 64 monitors a change in the commanded injection quantity of fuel. Step 65 monitors the operating noise (i.e., the combustion noise) of the diesel engine. These parameters are used as representing a change in state of the diesel engine. The operations in steps 63, 64, and 65 will be described below in detail.

### Step 63: Monitoring Change in Engine Speed

Step 63 determines whether the speed of the diesel engine has dropped upon the execution of the non-injection mode or not. If the speed is determined to have dropped (i.e., a NO answer is obtained), it is concluded that the operating condition of the diesel engine has been changed due to the execution of the non-injection mode. Specifically, it is determined in step 63 whether a difference NEa−NEb is smaller than a given value F or not. “NEa” represents the speed of the diesel engine before the execution of the non-injection mode. “NEb” represents the speed of the diesel engine upon the execution of the non-injection mode. If a NO answer is obtained meaning that the difference NEa−NEb is greater than the given value F, it is determined that the fuel injector 17 placed in the non-injection mode is operating properly.

If a NO answer is obtained meaning that the difference NEa−NEb is smaller than the given value F, it is determined that the operating condition of the diesel engine has not been changed due to the execution of the non-injection mode and, in step 67, that the fuel injector 17 placed in the non-injection mode is malfunctioning.

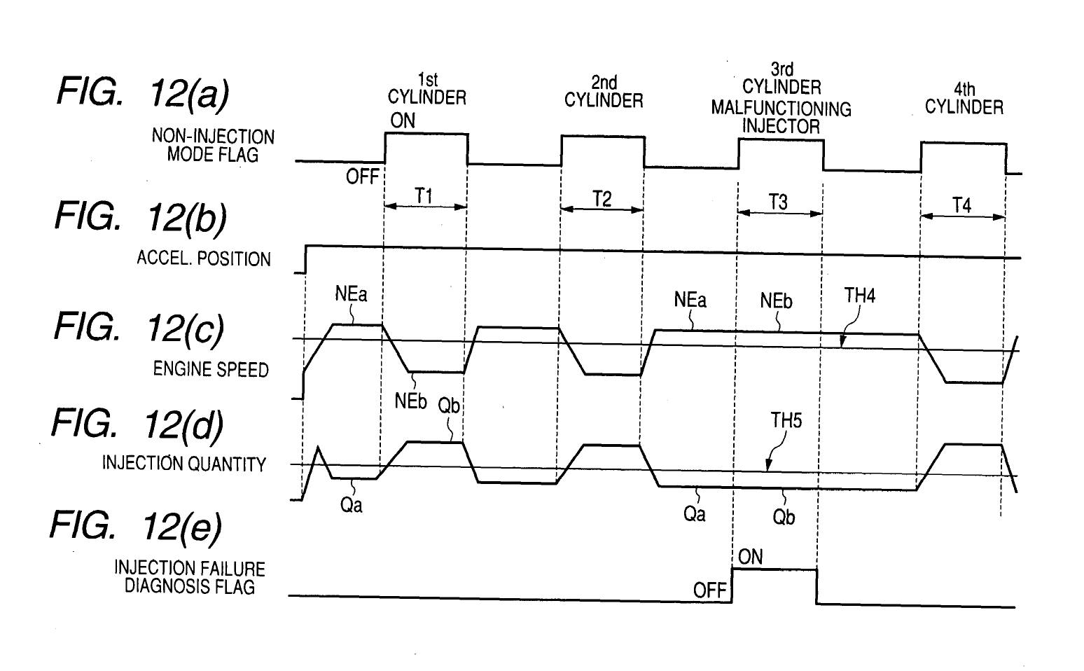

FIG. 12(a) demonstrates the non-injection mode flag indicating the execution of the non-injection mode. The fuel injectors 17 are placed in sequence in the non-injection mode for flag-on durations T1, 72, T3, and T4, respectively. The length of time the non-injection mode continues to be executed is selected to be longer than the engine combustion cycle, in other words, the injection command pulse signal to be outputted to each of the fuel injectors 17 is disabled several times for one of the flag-on durations T1, T2, T3, and T4. FIG. 12(b) demonstrates the state or position of the accelerator pedal as a function of the open position of the throttle valve. FIG. 12(c) demonstrates a change in speed of the diesel engine. FIG. 12(d) demonstrates a change in the commanded injection quantity. FIG. 12(e) demonstrates the status of the injection failure diagnosis flag, as set in step 67 of FIG. 10, FIG. 12(c) omits pulsations of an instantaneous variation in speed of the diesel engine for the brevity of illustration.

As can be seen from FIG. 12(b), upon execution of the engine speed accelerating operation, the opening of the throttle valve is increased. This causes the commanded injection quantity of fuel required to be sprayed from the fuel injector 17 to be increased, as illustrated in FIG. 12(d), to Qa to accelerate the speed of the diesel engine, as illustrated in FIG. 12(c), so that the speed of the engine will rise to NEa.

When the fuel injector 17 for the first cylinder #1 is placed in the non-injection mode for the duration T1 during the execution of the engine speed accelerating operation, the speed of the diesel engine will drop to NEb from NEa that is the speed of the diesel engine before the entry of the non-injection mode. The same applies to the durations T2 and T4 in which the fuel injectors 17 for the second and fourth cylinders #2 and #4 are placed in the non-injection mode. In contrast, when the fuel injector 17 for the third cylinder #3 which is malfunctioning is placed in the non-injection mode for the duration T3, the speeds NEa and ΔNEb of the engine before and after the execution of the non-injection mode will be the same.

In step 63, the determination may alternatively be made, as illustrated in FIG. 12(c), whether the speed of the engine exceeds a given threshold TH4 or not. If such a speed increase occurs, it is concluded that the speed of the diesel engine has been changed due to the execution of the non-injection mode.

### Step 64: Monitoring Change in Quantity of Fuel to be Sprayed

The execution of the non-injection mode for the fuel injector 17 which is operating properly during execution of the engine speed accelerating operation, as described above, results in a drop in speed of the engine, so that the commanded injection quantity of fuel is increased according to the map of FIG. 11. In contrast, the execution of the non-injection mode for the fuel injector 17 which is malfunctioning during execution of the engine speed accelerating operation results in no change in speed of the engine, so that the commanded injection quantity of fuel is kept constant.

In view of the above fact, step 42 determines whether Qb minus Qa is smaller than a given value G or not. “Qa” represents the commanded injection quantity, as determined before the non-injection mode is entered. “Qb” represents the commanded injection quantity, as determined when the non-injection mode is entered. If a difference (Qb−Qa) is greater than the given value G, that is, a NO answer is obtained in step 64, the ECU 30 determines that the commanded injection quantity of fuel has been increased and that the operating condition of the diesel engine has been changed due to the execution of the non-injection mode. Alternatively, if the difference (Qb−Qa) is smaller than the given value G, that is, a YES answer is obtained in step 64, the ECU 30 determines that the commanded injection quantity of fuel has not been increased and that the operating condition of the diesel engine has not been changed by the execution of the non-injection mode.

In step 64, the determination may alternatively be made based on the commanded injection quantity of fuel as determined upon the execution of the non-injection mode. Specifically, when the commanded injection quantity of fuel exceeds a given threshold value TH5, as illustrated in FIG. 12(d), it may be determined that the commanded injection quantity of fuel has been changed.

### Step 65: Monitoring Change in Engine Noise

When the fuel injectors 17 which are operating properly are placed in the non-injection mode during the execution of the engine speed accelerating operation, it will, as described above, result in an increase in commanded injection quantity of fuel, which leads to an increased variation in sprayed quantity of fuel among the cylinders. This results in an increase in pulsation of the speed of the diesel engine, so that the operating noise of the diesel engine increases. Additionally, an increase in quantity of fuel sprayed into one of the cylinders of the diesel engine will result in an increase in combustion noise arising from the burning of the fuel within the one of the cylinders. When the fuel injector 17 which is malfunctioning is placed in the non-injection mode for the duration T3, the variation in sprayed quantity of fuel among the cylinders is, as described above, not changed, thus causing the operating noise and combustion noise (i.e., the engine noise) not to be changed from those before the duration T3.

In view of the above fact, step 65 determines whether a change in level of the engine noise, as measured by a sound level sensor (not shown), is less than a given value H or not. If a NO answer is obtained meaning that the change in level of the engine noise greater than the given value H has occurred due to the execution of the non-injection mode, in other words, that the operating condition of the diesel engine has been changed by the execution of the non-injection mode. If a YES answer is obtained meaning that the engine noise is not changed, it is concluded that the operating condition of the diesel engine has not been changed due to the execution of the non-injection mode.

If YES answers are obtained all in steps 63, 64, and 65 meaning that the operating conditions of the diesel engine are not changed, the routine proceeds to step 67 wherein a selected one of the fuel injectors 17 is malfunctioning, so that no fuel is being sprayed. Alternatively, if a YES answer is obtained in at least one of steps 63, 64, and 65, it may be determined that the selected one of the fuel injectors 17 is malfunctioning. Any one or two of steps 63, 64, and 65 may be omitted.

This embodiment also offers the same advantages as the ones 1), 2), 3) and 4), as described above.

The ECU 30 of this embodiment may alternatively be designed to have only one or two of the injector operation disabling circuit 31, the state monitoring circuit 32, and the diagnosis circuit on the condition that the service tool 40 is designed to have the other or others of the injector operation disabling circuit 31, the state monitoring circuit 32, and the diagnosis circuit. For instance, the operator may joint the service tool 40 to the ECU 30 of the vehicle parked at the workshop of the dealer and operate the part of engine control tasks to be executed in the ECU 30 through the service tool 40 to perform the engine speed accelerating operation and initiate the malfunction monitoring program of FIG. 10.

While the present invention has been disclosed in terms of the preferred embodiments in order to facilitate better understanding thereof, it should be appreciated that the invention can be embodied in various ways without departing from the principle of the invention. Therefore, the invention should be understood to include all possible embodiments and modifications to the shown embodiments which can be embodied without departing from the principle of the invention as set fort in the appended claims.

For instance, the above embodiments may be modified as described below.

The give values A to G (or the threshold values TH1 to TH5), as used in the determinations in steps 42 to 44, 52, 53, and 63 to 65 are given as constant values, however, may be changed based on the controlled state or operating state of the diesel engine.

For example, when a required load on an accessory such as an air conditioner installed in the vehicle is increased, the diesel engine is being warmed up or running in cold conditions, the target idle speed A used in the ISC feedback mode is increased. In this case, changes in the commanded injection quantity of fuel, the speed of the diesel engine, and the engine noise when the fuel injector 17 which is operating properly is placed in the non-injection mode will increase. The given values A, B, and C used in steps 42 to 44 of the first embodiment are preferably increased to minimize an error of the determination in step 46 or 47.

In the first embodiment, the service tool 40 is equipped with the injector operation disabling circuit 41 working to perform the operation in step 41 of FIG. 4 and the state monitoring circuit 42 working to perform the operation in steps 42, 43, and 44 of FIG. 4. In the second embodiment, the ECU 30 is equipped with the injector operation disabling circuit 31 and the state monitoring circuit 32 which function like the injector operation disabling circuit 41 and the state monitoring circuit 42. An additional service tool may be used in the above embodiments which includes the state monitoring circuit 32 or 42. The change in engine noise may alternatively be detected acoustically by ears of a human operator.

The diagnosis circuit working to determine whether the fuel injectors 17 are malfunctioning or not may be installed in an additional service tool instead of the one in the ECU 30 or the service tool 40. In this case, a human operator visually perceives a change in state of the diesel engine, as sampled in the state monitoring circuit 32 or 42, and determines whether the fuel injectors 17 is malfunctioning or not.

In the first embodiment, the service tool 40 works in step 41 to disable the injection command pulse signal to stop the fuel injectors 17 from spraying the fuel in the non-injection mode, however, the placement of each of the fuel injectors 17 in the non-injection mode may alternatively be achieved by manually pulling one of connectors 17c of harnesses, as illustrated in FIG. 1 or 7, out of the fuel injectors 17. The harnesses are used to transmit the injection command pulse signals from the ECU 30 to the fuel injectors 17. The ECU 30, as installed in typical automotive vehicles, is usually designed to detect a disconnection of one of the connectors 17c from the fuel injector 17 and, thus, may initiate the malfunction monitoring program of FIG. 4, 8, or 10 when detecting such a disconnection.

The non-injection mode may alternatively be entered by inhibiting the ECU 30 from outputting the injection command pulse signal or nulling the injection command pulse signal in the ECU 30.

The above embodiments may be used to diagnose fuel injectors installed in gasoline-powered engines.

What is claimed is:

1. A fuel injector malfunction monitoring apparatus designed to monitor a malfunction of fuel injectors which are installed in cylinders of an internal combustion engine and work to spray fuel in response to a fuel injection command signal, comprising:
an injector operation disabling circuit which works to disable the fuel injection command signal to place a selected one of the fuel injectors in a non-injection mode during operation of the internal combustion engine; and
a state monitoring circuit working to monitor a state of the internal combustion engine upon placement of the selected one of the fuel injectors in the non-injection mode.

2. A fuel injector malfunction monitoring apparatus as set forth in claim 1, further comprising a diagnosis circuit working to diagnose whether the selected one of the fuel injectors is malfunctioning or not based on the state of the internal combustion engines as monitored by said state monitoring circuit, and wherein when the state of the internal combustion engine, as monitored by said state monitoring circuit, remains unchanged upon the placement of the selected one of the fuel injectors in the non-injection mode, said diagnosis circuit determines that the selected one of the fuel injectors is malfunctioning.

3. A fuel injector malfunction monitoring apparatus as set forth in claim 1, wherein the internal combustion engine is installed in an automotive vehicle, further comprising ISC means for determining a target quantity of fuel to be sprayed by the fuel injectors to place the internal combustion engine in an idle mode in which a speed of the internal combustion engine is kept above a given idle speed when a vehicle operator is releasing an accelerator, and wherein said injector operation disabling circuit places the selected one of the fuel injectors in the non-injection mode when the internal combustion engine is placed in the idle mode.

4. A fuel injector malfunction monitoring apparatus as set forth in claim 1, wherein the internal combustion engine is installed in an automotive vehicle, further comprising ISC means for determining a target quantity of fuel to be sprayed by the fuel injectors to place the internal combustion engine in an idle mode in which a speed of the internal combustion engine is kept above a given idle speed when a vehicle operator is releasing an accelerator, and wherein said injector operation disabling circuit places the selected one of the fuel injectors in the non-injection mode when the internal combustion engine is placed in an accelerator-response mode in which said injector operation disabling circuit determines a target quantity of fuel to be sprayed from the fuel injectors based on a position of the accelerator and a speed of the internal combustion engine, and the internal combustion engine is placed out of the idle mode.

5. A fuel injector malfunction monitoring apparatus as set forth in claim 4, further comprising engine speed accelerating means for accelerating the speed of the internal combustion engine without performing the ISC means when the automotive vehicle is being stopped, and the vehicle operator is releasing the accelerator, and wherein the accelerator-response mode is to execute said engine speed accelerating means.

6. A fuel injector malfunction monitoring apparatus as set forth in claim 1, wherein the internal combustion engine is installed in an automotive vehicle, further comprising during-deceleration fuel spraying smoothing means for decreasing a target quantity of the fuel to be sprayed from the fuel injectors smoothly when a vehicle operator is releasing an accelerator to decelerate the internal combustion engine, and wherein said injector operation disabling circuit places the selected one of the fuel injectors in the non-injection mode when said during-deceleration fuel spraying smoothing means is being executed.

7. A fuel injector malfunction monitoring apparatus as set forth in claim 1, wherein said state monitoring circuit monitors, as the state of the internal combustion engine, a change in quantity of fuel to be sprayed from the fuel injectors other than the selected one of the fuel injectors upon placement of the selected one of the fuel injectors in the non-injection mode.

8. A fuel injector malfunction monitoring apparatus as set forth in claim 1, wherein said state monitoring circuit monitors, as the state of the internal combustion engine, a change in speed of the internal combustion engine upon placement of the selected one of the fuel injectors in the non-injection mode.

9. A fuel injector malfunction monitoring apparatus as set forth in claim 1, wherein said state monitoring circuit monitors, as the state of the internal combustion engine, a change in operating noise of the internal combustion engine upon placement of the selected one of the fuel injectors in the non-injection mode.

10. A fuel injector malfunction monitoring apparatus as set forth in claim 1, wherein the internal combustion engine is installed as a power source in an automotive vehicle, and wherein said injector operation disabling circuit is installed in an electronic control unit mounted in the vehicle to control an operation of the fuel injectors and works to place the selected one of the fuel injectors in the non-injection mode in response to a non-injection request signal from outside the vehicle.

11. A fuel injector malfunction monitoring apparatus as set forth in claim 1, wherein the internal combustion engine is installed as a power source in an automotive vehicle, and wherein at least one of the said injector operation disabling circuit and said state monitoring circuit is installed in an external diagnosis device provided outside the vehicle.

12. A fuel injector malfunction monitoring method for monitoring a malfunction of fuel injectors which are installed in cylinders of an internal combustion engine and work to spray fuel in response to a fuel injection command signal comprising:
disabling the fuel injection command signal to place a selected one of the fuel injectors in a non-injection mode during operation of the internal combustion engine;
determining whether an operating condition of the internal combustion engine has been changed or not due to placement of the selected one of the fuel injectors in the non-injection mode; and
diagnosing that the selected one of the fuel injectors is malfunctioning when the operating condition of the internal combustion engine is determined not to have been changed.

13. A fuel injector malfunction monitoring method as set forth in claim 12, wherein the internal combustion engine is installed in an automotive vehicle which includes means for determining a target quantity of fuel to be sprayed by the fuel injectors to place the internal combustion engine in an idle mode in which a speed of the internal combustion engine is kept above a given idle speed when a vehicle operator is releasing an accelerator, and wherein said disabling step places the selected one of the fuel injectors in the non-injection mode when the internal combustion engine is placed in the idle mode.

14. A fuel injector malfunction monitoring method as set forth in claim 12, wherein the internal combustion engine is installed in an automotive vehicle which includes ISC means for determining a target quantity of fuel to be sprayed by the fuel injectors to place the internal combustion engine in an idle mode in which a speed of the internal combustion engine is kept above a given idle speed when a vehicle operator is releasing an accelerator, and wherein said disabling step places the selected one of the fuel injectors in the non-injection mode when the internal combustion engine is placed in an accelerator-response mode in which said disabling step determines a target quantity of fuel to be sprayed from the fuel injectors based on a position of the accelerator and a speed of the internal combustion engine, and the internal combustion engine is placed out of the idle mode.

15. A fuel injector malfunction monitoring method as set forth in claim 14, further comprising accelerating the speed of the internal combustion engine without performing the ISC means when the vehicle operator is releasing the accelerator, and wherein the selected one of the fuel injectors is placed in the non-injection mode when the speed of the internal combustion engine is being accelerated.

16. A fuel injector malfunction monitoring method as set forth in claim 1, wherein the internal combustion engine is installed as a power source in an automotive vehicle, and wherein said disabling step is achieved in an electronic control unit mounted in the vehicle to control an operation of the fuel injectors and works to disable the fuel injection command signal, as outputted from the electronic control unit, to place the selected one of the fuel injectors in the non-injection mode in response to a non-injection request signal from outside the vehicle.

17. A fuel injector malfunction monitoring method as set forth in claim 1, wherein the internal combustion engine is installed as a power source in an automotive vehicle, and wherein said disabling step is achieved in an electronic control unit mounted in the vehicle to control an operation of the fuel injectors and works to remove a connector of a harness through which the fuel injection command signal is transmitted from the electronic control unit to the fuel injectors to place the selected one of the fuel injectors in the non-injection mode.

18. A fuel injector malfunction monitoring method as set forth in claim 12, wherein said determining step determines whether an operating condition of the internal combustion engine has been changed or not based on a change in quantity of fuel to be sprayed from the fuel injectors other than the selected one of the fuel injectors upon placement of the selected one of the fuel injectors in the non-injection mode.

19. A fuel injector malfunction monitoring method as set forth in claim 12, wherein said determining step determines whether an operating condition of the internal combustion engine has been changed or not based on a change in speed of the internal combustion engine upon placement of the selected one of the fuel injectors in the non-injection mode.

20. A fuel injector malfunction monitoring method as set forth in claim 12, wherein said determining step determines whether an operating condition of the internal combustion engine has been changed or not based on a change in operating noise of the internal combustion engine upon placement of the selected one of the fuel injectors in the non-injection mode.
